(19) United States
(12) Patent Application Publication
(10) Pub. No.: US 2024/0424771 A1
(43) Pub. Date: Dec. 26, 2024

(54) ROLL MATERIAL FOR MANUFACTURING HEAT SEALABLE FILM AND HEAT SEALABLE FILM

(71) Applicant: YNB SUPPLY (ASIA) CORPORATION, New Taipei City (TW)

(72) Inventor: YEN-WU YANG, New Taipei City (TW)

(21) Appl. No.: 18/338,373

(22) Filed: Jun. 21, 2023

(51) Int. Cl. B32B 27/08; B32B 3/26; B32B 5/18; B32B 7/14; B32B 27/06; B32B 27/32; B32B 27/36; B65D 65/40

(52) U.S. Cl. CPC B32B 27/08; B32B 3/266; B32B 5/18; B32B 7/14; B32B 27/065; B32B 27/32; B32B 27/36; B65D 65/40; B32B 2255/10; B32B 2255/24; B32B 2255/26; B32B 2266/025; B32B 2307/31; B32B 2307/406; B32B 2307/408; B32B 2435/02

(57) ABSTRACT

A roll material comprises an adhesive sealing film and a lift lamination layer, located over the adhesive sealing film, including a backing layer and a functional film layer from top to bottom sequentially. The functional film layer has a PE film or an EPE film and a plurality of micro-adhesive blocks from top to bottom sequentially. The micro-adhesive blocks are coated with a release coating. With the roll material, a heat sealable film having a good re-sealing effect can be manufactured.

### BACKGROUND OF THE INVENTION

### 1. Field of the Invention

The present disclosure relates to a roll material, and more particularly to a roll material for manufacturing a heat sealable film.

### 2. Description of the Related Art

With the advancement of society, people have higher requirements for packaging and sealing of containers, with the considerations of convenience, hygiene, and safety of openings, as well as the shelf life after re-sealing. For example, a heat sealable film that is sealed by means of heating (to be simply referred to as a sealing film) is provided as a package seal of containers.

The above sealing film can seal an opening of a container, further providing advantages such as having good airtightness and leakproofness as well as enhancing added values of a product.

### BRIEF SUMMARY OF THE INVENTION

For a conventional sealing film, a user typically uses a tool to pierce, a blade to cut, or a fingernail to tear the sealing film, resulting in poor hygiene and poor safety during opening of the package seal. Moreover, once a conventional sealing film is torn off, re-sealing for further storage cannot be effectively carried out, in a way that the remaining content in the container may then have a shortened shelf life and be susceptible to spoilage.

Therefore, in the technical field of sealing films, there is a need for a solution to overcome the problems that re-sealing cannot be effectively carried out and storage is made difficult once a sealing film is torn off.

The roll material of the present disclosure can be used to manufacture a heat sealable film. More specifically, when a heat sealable film processed from the roll material of the present disclosure is torn off by means of pinching a lift portion (formed by micro-adhesive blocks in a lift lamination layer) by fingers, a container seal can be torn off along a tear line designed according to requirements. After the tearing off, a ring of adhesive sealing film and the lift lamination layer (which may serve as a re-sealing gasket) remains adhered on an upper surface of an opening of the container, providing a good re-sealing effect once a lid of the container is twisted tightly.

To solve the problems above and more, a roll material for manufacturing a heat sealable film according to an embodiment of the present disclosure includes an adhesive sealing film and a lift lamination layer, located over the adhesive sealing film. The lift lamination layer includes a backing layer and a functional film layer, from top to bottom sequentially. The functional film layer has a polyethylene (PE) film or an expandable polyethylene (EPE) film and a plurality of micro-adhesive blocks from top to bottom sequentially. The micro-adhesive blocks are coated with a release coating.

In an embodiment, the lift lamination layer has a tear line formed in collaboration by continuous curved line segments and non-continuous curved line segments.

In an embodiment, a polyethylene terephthalate (PET) film is further included over the PE film or the EPE film.

In an embodiment, the release coating is made of epoxy resin, silicone oil, varnish, or wax.

In an embodiment, a surface of the release coating is a glossy, matte, or lattice-like surface.

In an embodiment, a main base material of the adhesive sealing film is ethylene vinyl acetate (EVA), PE, polypropylene (PP), or PET.

In an embodiment, the backing layer includes a PET film and a PE thick film from top to bottom sequentially.

In an embodiment, corona treatment and printing treatment are sequentially performed on a surface of the PET film of the backing layer.

In an embodiment, the adhesive sealing film, the backing layer and the functional film layer contain a dry lamination adhesive between one another.

A heat sealable film according to an embodiment of the present disclosure includes the roll material above.

In an embodiment, the heat sealable film has a tear line, and a plurality of breakpoints is formed on a path of the tear line.

An embodiment of the present disclosure is completed in view of the above issues of the prior art, and an object thereof is to provide a roll material used for manufacturing a heat sealable film (to be simply referred to as a roll material below). With the roll material, a heat sealable film having a good re-sealing effect can be manufactured.

### BRIEF DESCRIPTION OF THE DRAWINGS

FIG. 1 is a schematic diagram of a roll material according to an embodiment of the present disclosure.

FIG. 2 is a schematic diagram of a functional film layer according to an embodiment of the present disclosure.

FIG. 3 is a schematic diagram of a backing layer according to an embodiment of the present disclosure.

FIG. 4 is a schematic diagram of a functional film layer according to an embodiment of the present disclosure.

FIG. 5 is a schematic diagram of a roll material according to an embodiment of the present disclosure.

FIG. 6 is a schematic diagram of a heat sealable film according to an embodiment of the present disclosure.

### DETAILED DESCRIPTION OF THE INVENTION

Implementation details of the present disclosure are described by way of specific embodiments for a person skilled in the art to understand other advantages and effects of the present disclosure on the basis of the disclosure of the present application. The present disclosure may be implemented or applied by other specific embodiments, and changes and modifications may also be made on the basis of different perspectives and applications to various details in the description without departing from the spirit of the present disclosure.

Unless otherwise specified in the literature, the expression “A to B” used in the description and the appended claims include the meaning “A or more and B or less”. For example, the expression “10 to 40 weight %” includes the meaning of “10 weight % or more and 40 weight % or less”.

### <Roll Material>

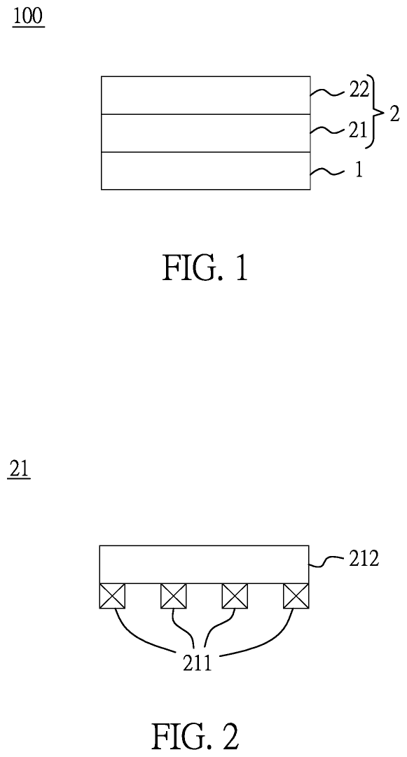

Refer to FIG. 1 showing a schematic diagram of a roll material according to an embodiment of the present disclosure. As shown in FIG. 1, a roll material 100 according to an embodiment of the present disclosure includes an adhesive sealing film 1, and a lift lamination layer 2 located over the adhesive sealing film 1.

### <Adhesive Sealing Film>

In a specific example, the main base material of the adhesive sealing film 1 may be ethylene vinyl acetate (EVA), polyethylene (PE), polypropylene (PP), or polyethylene terephthalate (PET). Moreover, the adhesive sealing film 1 may have a thickness of 12 to 60 μm. The adhesive sealing film is placed at the bottommost to allow a heat sealable film to be processed and manufactured from the roll material 100 to seal an opening of a container when the heat sealable film is used for heat sealing.

### <Lift Lamination Layer>

As shown in FIG. 1, the lift lamination layer 2 includes a backing layer 22 and a functional film layer 21 from top to bottom sequentially. The individual layers are described below.

### <<Functional Film Layer>>

Refer to FIG. 2 showing a schematic diagram of a functional film layer according to an embodiment of the present disclosure. As shown in FIG. 2, the functional film layer 21 includes a PE film (or EPE film) 212 and a plurality of micro-adhesive blocks 211 from top to bottom sequentially. The PE film (or EPE film) 212 may have a thickness of 30 to 150 μm, and the micro-adhesive blocks 211 may have a thickness of 10 to 100 μm.

The micro-adhesive blocks 211 are coated with a release coating, and the micro-adhesive blocks 211 are provided with ease of peeling by the release coating, preventing the micro-adhesive blocks 211 from being strongly adhered to other layers. To provide the micro-adhesive blocks 211 with better ease of peeling, the release coating may be made of epoxy resin, silicone oil, varnish, or wax, and a surface of the release coating is a glossy, matte, or lattice-like surface.

The number of the micro-adhesive blocks 211 may be the same as the number of the lift portions for lifting, and a position of each micro-adhesive block corresponds to a position of each lift portion. In addition, the lift portion, hollow portion, and tear line to be described shortly are designed and formed according to product or customer requirements, so as to facilitate a user to pinch the lift portion using fingers and thus easily tear off the sealing film. The hollow portion allows a user to readily apply a force so as to pinch the lift portion. Moreover, the tear line is preferably non-continuous line segments, that is, a plurality of breakpoints is formed on a path of the tear line, and the number of the breakpoints is not specifically defined. Thus, the backing layer and the functional film layer can be more securely combined during processing, so as to prevent damage of the individual layers.

Refer to FIG. 4 showing a schematic diagram of a functional film layer according to an embodiment of the present disclosure. Depending on circumstances, a PET film may be added to the functional film layer to adhere the PET film 213 with the PE film (or EPE film) 212 by a dry lamination adhesive. As shown in FIG. 4, a functional film layer 21′ includes a PET film 213, a dry lamination adhesive 9, a PE film (or EPE film) 212, and a plurality of micro-adhesive blocks 211 from top to bottom sequentially. The PE film (or EPE film) 212 and the micro-adhesive blocks 211 are the same as those disclosed in the description related to the functional film layer 21. The PET film 213 may have a thickness of 12 to 60 μm and the dry lamination adhesive 9 may have a thickness of 3 to 5 μm.

The functional film layers 21, 21′ are placed below the backing layer 22, such that when fingers pinch and lift the lift portion and tear off the sealing film along the tear line after sealing by the processed and manufactured sealing film, a pinching force of the fingers and a break-resistance strength during lifting can be reinforced.

### <<Backing Layer>>

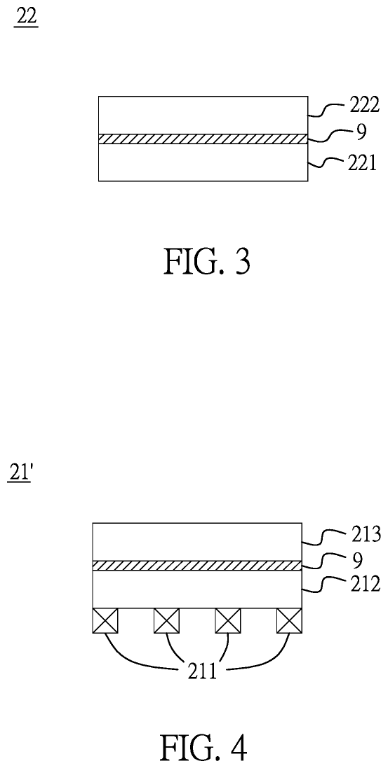

FIG. 3 shows a schematic diagram of a backing layer according to an embodiment of the present disclosure. As shown in FIG. 3, the backing layer 22 includes a PET film 222, a dry lamination adhesive 9, and a PE thick film 221 from top to bottom sequentially. The PET film 222 may have a thickness of 12 to 60 μm, the dry lamination adhesive 9 may have a thickness of 3 to 5 μm, and the PE thick film 221 may have a thickness of 60 to 200 μm.

In an embodiment, corona treatment and printing treatment are sequentially performed on a surface of the PET film of the backing layer. Thus, the PET film 222 in the backing layer 22 can exhibit a flat and bright look after printing, and then be laminated with the PE thick film 221.

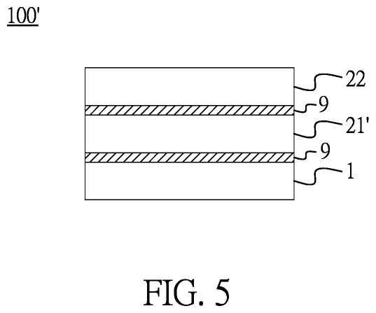

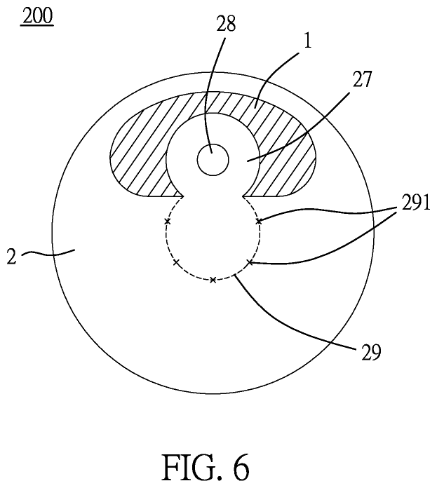

Next, refer to FIG. 5 showing a schematic diagram of a roll material according to an embodiment of the present disclosure. As shown in FIG. 5, a roll material 100′ includes a backing layer 22, a functional film layer 21′, and an adhesive sealing film 1. The backing layer 22, the functional film layer 21′, and the adhesive sealing film 1 contain the dry lamination adhesive 9 between one another. With the dry lamination adhesive 9, the lamination strength between the individual layers can be reinforced.

The details regarding the backing layer 22, the functional film layer 21′, the adhesive sealing film 1, and the dry lamination adhesive 9 are the same as those given in the description of the embodiments above, and are omitted herein.

### <<Manufacturing of Sealing Film>>

The roll material 100′ of the embodiment above is manufactured on the basis of the steps below. Moreover, in response to sizes and shapes of different product or customer requirements, the roll material 100′ is punched and cut with a punching die of a punching machine to obtain the heat sealable film according to customer requirements.

### (Manufacturing of Backing Layer)

First of all, corona treatment is performed on one surface of the PET film, wherein this surface serves as a surface to be printed of the PET film. Next, patterns are printed on the surface to be printed of the PET film in the form of printing (printing treatment) to obtain a printed PET film. At this point, observing from a non-printing surface of the PET film, in contribution to the backing of the PET film, the PET film exhibits a flat and bright printing look. Then, the printed surface of the PET film is used as a surface to be laminated. The corona treatment above provides the surface to be printed (also the surface to be laminated) with a surface tension of dyne/cm or more.

Next, corona treatment is performed on one surface of the PE thick film, and this surface serves as a surface to be laminated of the PE thick film. The corona treatment above provides the surface to be printed and the surface to be laminated with a surface tension of 40 dyne/cm or more. Then, the surface to be laminated of the printed PET film is coated with the dry lamination adhesive, passed through a baking tunnel at a speed of 20 to 120 m/min (preferably, four temperature levels including 58 to 62° C., 68 to 72° C., 73 to 77° C. and 78 to 82° C. are set in the baking tunnel), passed through a heated lamination roller (preferably at a temperature of 50 to 60° C.) at a speed of 50 to 60 m/min, adhered and pressed tight with the surface to be laminated of the PE thick film, and cured for 48 hours at room temperature, so as to obtain the backing layer.

### (Manufacturing of Functional Film Layer Base Material)

Next, corona treatment is performed on one surface of the PET film, and this surface serves as a surface to be laminated of the PET film. Next, corona treatment is performed on one surface of the PE film (or EPE film), and this surface serves as a surface to be laminated of the PE film (or EPE film). Next, the surface to be laminated of the PET film is coated with a dry lamination adhesive, passed through a baking tunnel and a heated lamination roller, adhered and pressed tight with the surface to be laminated of the PE film (or EPE film), and cured for 48 hours at room temperature, so as to obtain a functional film layer base material A. Then, corona treatment is performed on the other surface of the PET film in the functional film layer base material A, wherein this surface serves as a surface to be laminated of the functional film layer base material A. The corona treatment above provides the surface to be laminated with a surface tension of 40 dyne/cm or more, and processing conditions for passing through a baking tunnel and a heated lamination roller are the same as those in the manufacturing for the backing layer above.

The PET film and the dry lamination adhesive may also be omitted to obtain a functional film layer base material B having a PE film (or EPE film) having only one surface processed by corona treatment, and this surface processed by corona treatment is used as the surface to be laminated.

### (Manufacturing of Adhesive Sealing Film)

Next, corona treatment is performed on one surface of the adhesive sealing film (which has EVA, PE, PP, or PET as a main base material), wherein this surface serves as a surface to be laminated of the adhesive sealing film. The corona treatment above provides the surface to be laminated with a surface tension of 40 dyne/cm or more.

### (Lamination of Backing Layer and Functional Film Layer Base Material)

First of all, corona treatment is performed on one surface of the PE thick film in the backing layer, and this surface serves as a surface to be laminated of the backing layer. Next, the surface to be laminated of the backing layer is coated with a dry lamination adhesive, passed through a baking tunnel and a heated lamination roller, adhered and pressed tight with the surface to be laminated of the functional film layer base material (A or B) above, and cured for 48 hours at room temperature, so as to obtain the backing layer and the functional film layer base material (A or B). The corona treatment above provides the surface to be laminated with a surface tension of 40 dyne/cm or more, and processing conditions for passing through a baking tunnel and a heated lamination roller are the same as those in the manufacturing for the backing layer above.

### (Manufacturing of Lift Lamination Layer)

Corona treatment is performed on one surface of the PE film (or EPE film) of the functional film layer base material (A or B) in the backing layer and the functional film layer base material (A or B), and this surface serves as a surface to be coated of a lift lamination layer base material. The corona treatment above provides the surface to be coated with a surface tension of 40 dyne/cm or more.

Next, for the lift portion, the tear line, and the hollow portion that meet different requirements, positions of the lift lamination layer base material corresponding to a plurality of lift portions in the roll material are used as positions to be coated in the surface to be coated of the lift lamination layer base material. By coating with a release coating, a plurality of micro-adhesive blocks in the functional film layer is formed so as to obtain the lift lamination layer.

Then, the lift lamination layer is punched and cut for the lift portion, the hollow portion, and the tear line by using a punching machine, so as to form the lift portion, the hollow portion, and the tear line that meet different requirements. Moreover, in the lift lamination layer, a tear line is formed in collaboration by continuous curved line segments and non-continuous curved line segments.

FIG. 6 shows a schematic diagram of a heat sealable film 200 according to an embodiment of the present disclosure. As shown in FIG. 6, the heat sealable film 200 includes an adhesive sealing film 1 and a lift lamination layer 2 located thereon, and the lift lamination layer 2 has a lift portion 27 of a specific shape, a hollow portion 28, and a tear line 29 formed thereon. The hollow portion 28 allows a user to readily apply a force so as to pinch the lift portion 27. By using a mold having a non-continuous profile, the tear line 29 has a plurality of breakpoints 291 formed on its path and becomes non-continuous line segments. Moreover, in this embodiment, once a user tears the lift lamination layer 2 along the tear line 29, a space for inserting a straw can be formed.

### (Manufacturing of Roll Material)

First of all, corona treatment is performed on one surface of the PE film (or EPE film) having micro-adhesive blocks in the lift lamination layer, wherein this surface serves as a surface to be laminated of the lift lamination layer. The corona treatment above provides the surface to be laminated with a surface tension of 40 dyne/cm or more.

Next, the surface to be laminated of the lift lamination layer is coated with a dry lamination adhesive, passed through a baking tunnel and a heated lamination roller, adhered and pressed tight with the surface to be laminated of the adhesive sealing film, and cured for 48 hours at room temperature, so as to obtain a roll material 100′ according to an embodiment of the present disclosure. With the roll material 100′, a heat sealable film having a good re-sealing effect can be manufactured. The corona treatment above provides the surface to be laminated with a surface tension of 40 dyne/cm or more, and processing conditions for passing through a baking tunnel and a heated lamination roller are the same as those in the manufacturing for the backing layer above.

It should be noted that, the description above provides only a specific example, and the orders for manufacturing the individual layers are not specifically defined. Moreover, although the manufacturing of the roll material 100′ is given as an example for illustration purposes, the functional film layer 21 may also be used in substitution for the functional film layer 21′, and other lamination (adhesion, bonding or connection) means may also be used in substitution for the dry lamination adhesive 9.

It should be noted that the present invention is not limited to the various embodiments described above, and various modifications made be made within the scope of the appended claims. Moreover, implementation forms arrived by appropriately combining the technical means disclosed in the embodiments described above are also encompassed within the technical scope of the present invention.

What is claimed is:

1. A roll material for manufacturing a heat sealable film, the roll material comprising:
an adhesive sealing film; and
a lift lamination layer, located over the adhesive sealing film, the lift lamination layer comprising a backing layer and a functional film layer from top to bottom sequentially;
wherein, the functional film layer comprises a polyethylene (PE) film or an expandable polyethylene (EPE) film and a plurality of micro-adhesive blocks from top to bottom sequentially, and the micro-adhesive blocks are coated with a release coating.

2. The roll material according to claim 1, wherein the lift lamination layer has a tear line formed in collaboration by continuous curved line segments and non-continuous curved line segments.

3. The roll material according to claim 1, wherein the PE film or the EPE film further comprises a polyethylene terephthalate (PET) film thereon.

4. The roll material according to claim 1, wherein the release coating is made of epoxy resin, silicone oil, varnish, or wax.

5. The roll material according to claim 1, wherein a surface of the release coating is a glossy, matte, or lattice-like surface.

6. The roll material according to claim 1, wherein a main base material of the adhesive sealing film is ethylene vinyl acetate (EVA), PE, polypropylene (PP), or PET.

7. The roll material according to claim 1, wherein the backing layer comprises a PET film and a PE thick film from top to bottom sequentially.

8. The roll material according to claim 1, wherein the adhesive sealing film, the backing layer, and the functional film layer contain a dry lamination adhesive between one another.

9. A heat sealable film, comprising the roll material according to claim 1.

10. The heat sealable film according to claim 9, having a tear line, wherein a plurality of breakpoints is formed on a path of the tear line.
